(19) United States
(12) Patent Application Publication
(10) Pub. No.: US 2010/0176180 A1
(43) Pub. Date: Jul. 15, 2010

(54) Gas nail gun

(75) Inventor: Yu-Chuan Ho, Taichung County (TW)

Correspondence Address: BACON & THOMAS, PLLC, 625 SLATERS LANE, FOURTH FLOOR, ALEXANDRIA, VA, 22314-1176, US

(73) Assignee: SUPERIOR POWER TOOL CO., LTD., Taichung County (TW)

(21) Appl. No.: 12/318,887

(22) Filed: Jan. 12, 2009

(51) Int. Cl. B25C 1/04

(52) U.S. Cl. 227/130

(57) ABSTRACT

A gas nail gun includes a trigger, a pivoted baffle plate, and a liftable safety rod. When the safety rod is kept in the non-triggering position and not stopped against the workpiece, the baffle plate stops the trigger from operation. When the safety rod is stopped against the workpiece and lifted to the triggering position, the baffle plate is biased, allowing the trigger to be pressed. When the trigger is pressed and stopped against the baffle plate, the trigger is hooked up with a hook of the baffle plate so that the baffle plate is prohibited from biasing upon stoppage of the safety rod against the workpiece, avoiding accidental triggering of the trigger.

### BACKGROUND OF THE INVENTION

1. Field of the Invention

The present invention relates to gas-operated tools and more particularly, to a gas nail gun, which is equipped with a safety mechanism, assuring safety.

2. Description of the Related Art

U.S. Pat. No. 4,483,280 discloses a gas-powered hand tool, entitled “Portable gas-powered tool with linear motor”. According to this design, as shown in FIG. 6 of the specification, when pressed the trigger button (194) before without stopping the main lifting rod (150) against the workpiece, the flange (240) of the trigger button (194) is stopped by the latch arm (244) of the trigger latch (242) so that the latch arm (244) prevents trigger actuating movement of the trigger (194) by virtue of engagement between the latch arm (244) and the flange (240).

When the main lifting rod (150) is stopped against the workpiece and lifted, the ring arm (252) of the ring (250) pivots the safety latch (242) in a clockwise direction to move the latch arm (244) out of engagement with flange (240) of the trigger button (194). The trigger button (194) is now free to move and to perform the triggering action.

If the user presses the tripper button (194) to force the flange (240) of the trigger button (194) into engagement with the latch arm (244) of the trigger latch (242) and then stops the main lifting rod (150) against the workpiece, the latch arm (244) of the trigger latch (242) will be disengaged from the flange (240) of the tripper button (194) due to a clockwise biasing of the trigger latch (242). At this time, the trigger button (194) may be triggered accidentally, resulting in an accident.

### SUMMARY OF THE INVENTION

The present invention has been accomplished under the circumstances in view. It is the main object of the present invention to provide a gas nail gun, which has a trigger safety mechanism, preventing accidental triggering.

To achieve this and other objects of the present invention, a gas nail gun comprises a housing, a trigger, a baffle plate, and a safety rod. The trigger is mounted in the housing and pressable by a user to drive a nail out of the housing. The baffle plate is pivotally mounted in the housing and biasable between a stop position and a release position. The baffle plate comprises a stop flange and a hook extending from the stop flange. The stop flange stops the trigger from triggering when the baffle plate is in the stop position. The stop flange is moved away from the trigger for enabling the trigger to be pressed by a user when the baffle plate is in the release position. The hook is hooked on the trigger to prohibit movement of the baffle plate from the stop position to the release position when the trigger is stopped against the stop flange. The safety rod is mounted in the housing and movable relative to the housing between a triggering position and a non-triggering position. The safety rod comprises a bearing portion. The bearing portion of the safety rod is released from the baffle plate for enabling the baffle plate to be biased from the stop position to the release position when the safety rod is in the triggering position. The bearing portion of the safety rod is stopped against the baffle plate to hold the baffle plate in the stop position when the safety rod is in the non-triggering position.

Thus, when the user presses the trigger and stops the safety rod against the workpiece to move the safety rod to the triggering position, the hook of the baffle plate is hooked on the trigger to prevent biasing of the baffle plate toward the release position, and therefore the trigger is prohibited from triggering, assuring high safety.

### BRIEF DESCRIPTION OF THE DRAWING

FIG. 1 is a sectional side view of a gas nail gun in accordance with the present invention.

FIG. 2 is an enlarged view of a part of FIG. 1, showing the baffle plate in the stop position and the safety rod in the non-triggering position.

FIG. 3 is similar to FIG. 2 but showing the baffle plate in the release position and the safety rod in the triggering position.

FIG. 4 is similar to FIG. 3 but showing the baffle plate in the stop position and the safety rod in the triggering position.

FIG. 5 is an enlarged view of a part of FIG. 4, showing the hook of the baffle plate hooked on the sidewall of the trigger.

### DETAILED DESCRIPTION OF THE INVENTION

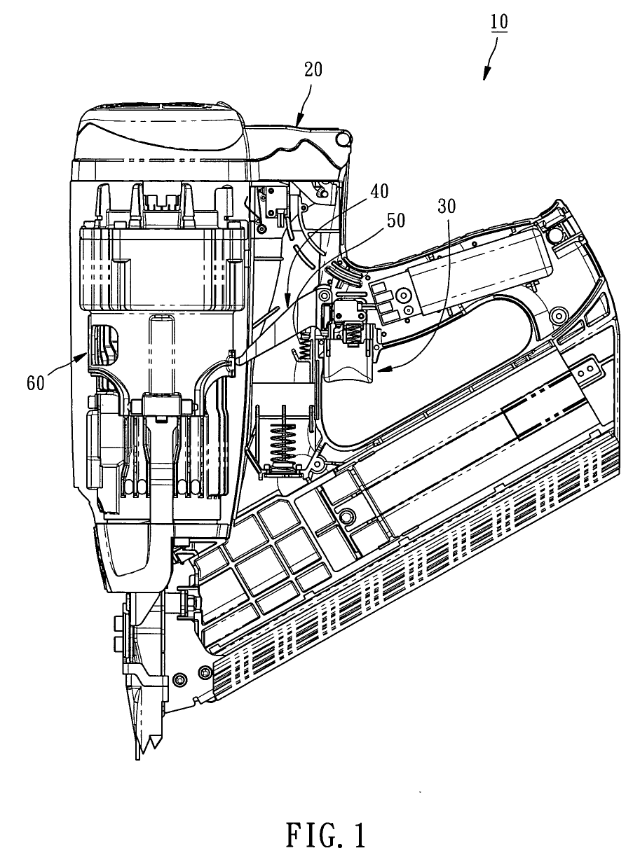

Referring to FIG. 1, a gas nail gun 10 in accordance with the present invention comprises a housing 20, a trigger 30, a baffle plate 40, a spring member 50, and a safety rod 60.

The trigger 30 is mounted in the housing 20 and can be pressed by an external force to achieve a triggering action.

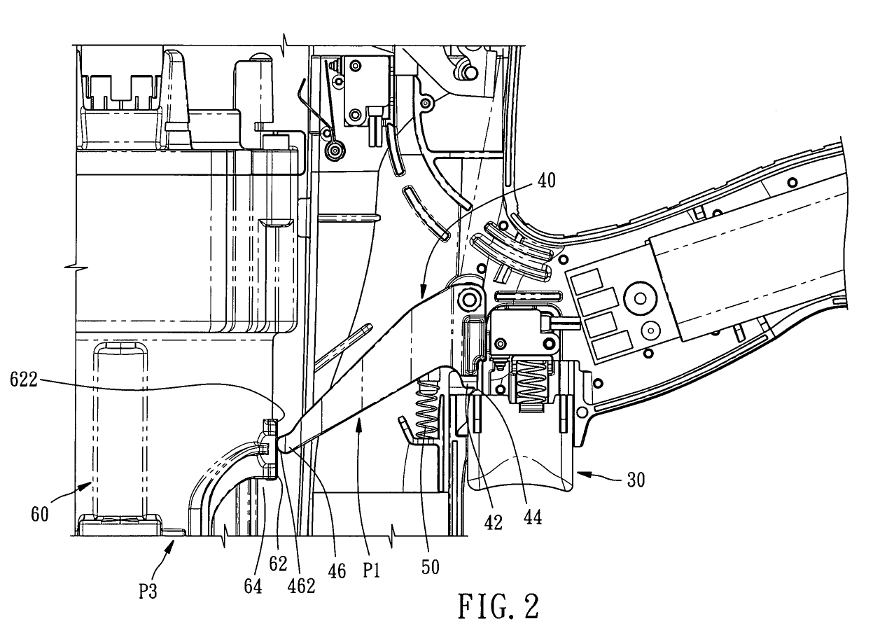

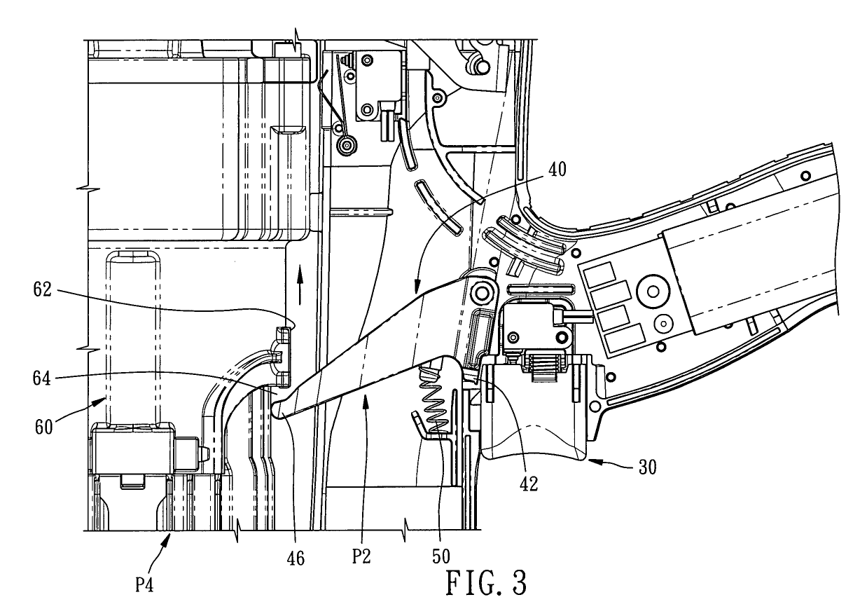

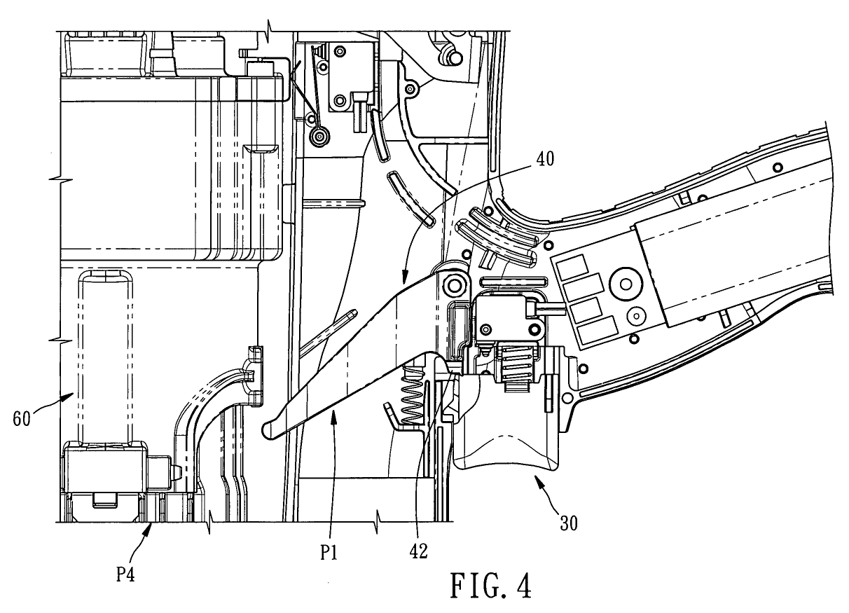

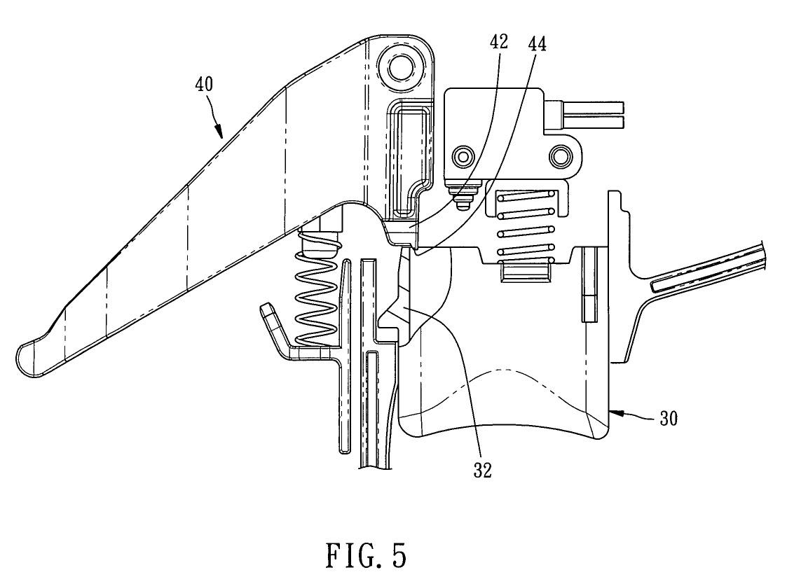

The baffle plate 40 is pivotally mounted in the housing 20, and biasable between a stop position P1 and a release position P2. The baffle plate 40 has a stop flange 42 at its rear bottom side, and a hook 44 extended from the stop flange 42. When the baffle plate 40 is in the stop position P1 as shown in FIG. 2, the stop flange 42 stops the trigger 30, preventing trigger actuating movement of the trigger 30. When the baffle plate 40 is in the release position P2 as shown in FIG. 3, the stop flange 42 is kept away from the trigger 30, allowing trigger actuating movement of the trigger 30. When the baffle plate 40 is in the stop position P1 and the trigger 30 is stopped against the stop flange 42, the hook 44 is hooked on one sidewall 32 of the trigger 30, prohibiting movement of the trigger 30 from the stop position P1 to the release position P2, as shown in FIGS. 4 and 5. Further, the baffle plate 40 has a front bearing end 46 that has a smoothly arched surface 462.

The spring member 50 is mounted inside the housing 20, and stopped with its top end against the baffle plate 40, imparting a pressure to the baffle plate 40 to move the baffle plate 40 from the stop position P1 shown in FIG. 2 to the release position P2 shown in FIG. 3.

The safety rod 60 is mounted in the housing 20, and movable vertically relative to the housing 20 between a non-triggering position P3 and a triggering position P4. Further, the safety rod 60 comprises a bearing portion 62 and a recess 64 abutted against the bearing portion 62. The bearing portion 62 has a plane 622. When the safety rod 60 is in the non-triggering position P3 shown in FIG. 2, the smoothly arched surface 462 of the front bearing end 46 of baffle plate 40 is stopped against the plane 622 of the bearing portion 62 of the bearing portion 62, holding the baffle plate 40 in the stop position P1. When the safety rod 60 is in the triggering position P4 shown in FIG. 3, the front bearing end 46 of baffle plate 40 is moved away from the bearing portion 62 of the bearing portion 62 and inserted into the recess 64 of the safety rod 60, enabling the baffle plate 40 to be biased by the spring member 50 from the stop position P1 to the release position P2.

When operating the gas nail gun, press the safety rod 60 against the workpiece to let the safety rod 60 to be lifted to the triggering position P4 shown in FIG. 3. At this time, the front bearing end 46 of the baffle plate 40 is kept in the recess 64 of the safety rod 60, and therefore the baffle plate 40 is biased by the spring member 50 from the stop position P1 shown in FIG. 2 to the release position P2 shown in FIG. 3. The user can then press the trigger 30 to drive a nail out of the gas nail gun. When the user press the trigger 30 again after one nail has been driven out of the gas nail gun, the baffle plate 40 is stopped by the outer side of the trigger 30 and prohibited from backward displacement, and therefore the safety rod 60 is prohibited from moving downwards. After the end of the work and removal of the safety rod 60 from the workpiece, the safety rod 60 moves downwards from the triggering position P4 shown in FIG. 3 to the non-triggering position P3 shown in FIG. 2. During downward movement of the safety rod 60, the peripheral wall of the recess 64 is moved over the front bearing end 46 of the baffle plate 40, biasing the baffle plate 40 from the release position P2 toward the stop position P1 and simultaneously compressing the spring member 50. At the time the front bearing end 46 of the baffle plate 40 moves away from the recess 64 of the safety rod 60, the baffle plate 40 is forced by the spring member 50 to stop the smoothly arched surface 462 of its front bearing end 46 against the plane 622 of the bearing portion 62 of the bearing portion 62, and therefore the baffle plate 40 is held in the stop position P1. At this time, the trigger 30 is stopped by the stop flange 42 of the baffle plate 40 and prohibited from trigger actuating movement.

If the user presses the trigger 30 accidentally when stopping the safety rod 60 against the workpiece to have the safety rod 60 be moved to the triggering position P4, the hook 44 of the baffle plate 40 is hooked on the sidewall 32 of the trigger 30, prohibiting movement of the trigger 30 from the stop position P1 to the release position P2, as shown in FIGS. 4 and 5. Therefore, the stop flange 42 of the baffle plate 40 can still stop the trigger 30 from operation when the safety rod 60 is kept in the triggering position P4, preventing an accidental triggering. If the safety rod 60 is kept stopped against the workpiece, the user can unlock the trigger 30, i.e., move the baffle plate 40 from the stop position P1 to the release position P2, and then press the trigger 30 to drive a nail out of the gas nail gun.

As stated above, the preferred embodiment of the present invention uses a biasable baffle plate to control triggering operation of the trigger. This structural design is quite simple. The hook of the baffle plate is hooked on the trigger when the trigger is pressed before the user stops the safety rod against the workpiece, therefore the baffle plate prevents an accidental triggering when the user stops the safety rod against the workpiece, assuring high safety.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A gas nail gun, comprising:
a housing;
a trigger mounted in said housing and pressable by a user to drive a nail out of said housing;
a baffle plate pivotally mounted in said housing and biasable between a stop position and a release position, said baffle plate comprising a stop flange and a hook extending from said stop flange, said stop flange stopping said trigger from triggering when said baffle plate is in said stop position, said stop flange being moved away from said trigger for enabling said trigger to be pressed by a user when said baffle plate is in said release position, said hook being hooked on said trigger to prohibit movement of said baffle plate from said stop position to said release position when said trigger is stopped against said stop flange; and
a safety rod mounted in said housing and movable relative to said housing between a triggering position and a non-triggering position, said safety rod comprising a bearing portion, the bearing portion of said safety rod being released from said baffle plate for enabling said baffle plate to be biased from said stop position to said release position when said safety rod is in said triggering position, the bearing portion of said safety rod being stopped against said baffle plate to hold said baffle plate in said stop position when said safety rod is in said non-triggering position,

2. The gas nail gun as claimed in claim 1, wherein said safety rod comprises a recess abutted against said bearing portion; said baffle plate comprises a bearing end, the bearing end of said baffle plate being moved away from said bearing portion of said safety rod and forced into said recess for enabling said baffle plate to be biased from said stop position to said release position when said safety rod is in said triggering position.

3. The gas nail gun as claimed in claim 2, wherein said bearing end of said baffle plate comprises a smoothly arched surface stopped against the bearing portion of said safety rod.

4. The gas nail gun as claimed in claim 1, further comprising a spring member adapted to provide a biasing force to said baffle plate to bias said baffle plate from said stop position toward said release position.

5. The gas nail gun as claimed in claim 1, wherein said bearing portion of said safety rod comprises a plane for stopping against said trigger.
